(19) United States
(12) Patent Application Publication
(10) Pub. No.: US 2025/0331019 A1
(43) Pub. Date: Oct. 23, 2025

(54) Methods For Initiating Downlink Procedure Associated With An Unlicensed Band In Mobile Communications

(71) Applicant: MediaTek Inc., Hsinchu City (TW)

(72) Inventors: Chun-Hao Fang, Hsinchu City (TW); Lung-Sheng Tsai, Hsinchu City (TW)

(21) Appl. No.: 19/173,693

(22) Filed: Apr. 8, 2025

Related U.S. Application Data
(60) Provisional application No. 63/634,948, filed on Apr. 17, 2024.

(51) Int. Cl. H04W 74/0808; H04W 16/14

(52) U.S. Cl. CPC H04W 74/0808; H04W 16/14

(57) ABSTRACT

Various solutions for initiating downlink procedure associated with unlicensed band with respect to an apparatus in mobile communications are described. The apparatus may determine a triggering event for performing a Listen-Before-Talk (LBT) procedure. The apparatus may determine a time of performing the LBT procedure based on the triggering event. The apparatus may perform the LBT procedure at the time to obtain a Channel Occupancy Time (COT). The apparatus may transmit COT information to another apparatus for signal forwarding for a time duration. The time duration may be associated with the COT.

### CROSS REFERENCE TO RELATED PATENT APPLICATION(S)

The present disclosure is part of a non-provisional application claiming the priority benefits of U.S. Patent Application No. 63/634,948, filed on 17 Apr. 2024, the content of which herein being incorporated by reference in its entirety.

### TECHNICAL FIELD

The present disclosure is generally related to mobile communications and, more particularly, to initiating downlink procedure associated with unlicensed band with respect to apparatus in mobile communications.

### BACKGROUND

Unless otherwise indicated herein, approaches described in this section are not prior art to the claims listed below and are not admitted as prior art by inclusion in this section.

In New Radio (NR) mobile communication systems, a collaborative device may be deployed to enhance communication flexibility and robustness. In particular, a network node may connect to a user equipment (UE) and the collaborative device over a licensed band. The collaborative device may connect to the UE over an unlicensed band. Based on this architecture, the network node may transmit a signal to the UE and the collaborative device over the licensed band. Further, after receiving the signal, the collaborative device may process the received signal before transmitting it to the UE over the unlicensed band. Accordingly, the UE may receive the signal from a direct path (i.e., from the network node over the licensed band) and the processed signal from an indirect path (i.e., from the collaborative device over the unlicensed band).

In some scenarios, the network node may transmit downlink (DL) data to the UE via the direct path and the indirect path. However, regarding the indirect path, to access the unlicensed band as communication channel between the UE and the collaborative device for forwarding the DL data, uncertainty may exist on the availability of the local-link channel (i.e., the channel between the UE and the collaborative device). Therefore, the procedures for forwarding DL data from the network node to the UE via the collaborative device should be well designed to improve overall network efficiency.

Accordingly, how to design the procedure for forwarding DL data from the network node to the UE via the collaborative device becomes important issues in the newly developed wireless communication network, and there is an urgent need to provide proper schemes to design the procedure for forwarding DL data from the network node to the UE via the collaborative device.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to initiating downlink procedure associated with unlicensed band with respect to apparatus in mobile communications.

In one aspect, a method may involve an apparatus determining a triggering event for performing a Listen-Before-Talk (LBT) procedure. The method may also involve the apparatus determining a time of performing the LBT procedure based on the triggering event. The method may also involve the apparatus performing the LBT procedure at the time to obtain a Channel Occupancy Time (COT). For example, the LBT procedure comprises energy detection for a certain period and successfully obtains a COT for possible signal transmission/forwarding if the detected energy is below than a threshold. The method may also involve the apparatus transmitting COT information to another apparatus for signal forwarding for a time duration. The time duration is associated with the COT.

In one aspect, a method may involve an apparatus obtaining a control information associated with a triggering event. The method may also involve the apparatus determining the triggering event for performing an LBT procedure based on the control information. The method may also involve the apparatus determining a time of performing the LBT procedure based on the triggering event. The method may also involve the apparatus forwarding a received signal for a time duration in an event that the LBT procedure is successful.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), Industrial Internet of Things (IIoT), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting example scenarios under schemes in accordance with implementations of the present disclosure.

FIG. 2 is a diagram depicting example scenarios under schemes in accordance with implementations of the present disclosure.

FIG. 3 is a diagram depicting example scenarios under schemes in accordance with implementations of the present disclosure.

FIG. 4 is a diagram depicting example scenarios under schemes in accordance with implementations of the present disclosure.

FIG. 5 is a diagram depicting example scenarios under schemes in accordance with implementations of the present disclosure.

FIG. 6 is a diagram depicting example scenarios under schemes in accordance with implementations of the present disclosure.

FIG. 7 is a diagram depicting example scenarios under schemes in accordance with implementations of the present disclosure.

FIG. 8 is a block diagram of an example communication system in accordance with an implementation of the present disclosure.

FIG. 9 is a flowchart of an example process in accordance with an implementation of the present disclosure.

FIG. 10 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to initiating downlink procedure associated with unlicensed band in mobile communications. According to the present disclosure, a number of possible solutions may be implemented separately or jointly. That is, although these possible solutions may be described below separately, two or more of these possible solutions may be implemented in one combination or another.

Regarding the present disclosure, a network node may wirelessly connect to a user equipment (UE) and a collaborative device over a licensed band. The UE and the collaborative device may connect with each other over an unlicensed band. The network node may transmit downlink (DL) data to the UE via: (1) a direct path between the UE and the network node, and (2) an indirect path from the network node to the UE via the collaborative device. It should be noted that when the collaborative device forwards the DL data from the network to the UE, the collaborative device may perform Frequency Translation-forwarding (FT-forwarding) which may transform signal(s) from the licensed band to the unlicensed band.

In some scenarios, when the network node has DL data to be transmitted to the UE, a procedure for forwarding DL data from the network node to the UE via the collaborative device may be initiated by the UE. In particular, the UE may receive/determine a triggering event for performing a sensing procedure with the collaborative device. The UE may determine a time of performing the sensing procedure based on the triggering event. The UE may perform the sensing procedure at the time to obtain a Channel Occupancy Time (COT). Then, the UE may transmit the COT information to the collaborative device so that the collaborative device may forward the signal for a time duration while the time duration is associated with the COT (e.g., the time duration is constrained or limited by the COT).

In some scenarios, when the network node has DL data to be transmitted to the UE, a procedure for forwarding DL data from the network node to the UE via the collaborative device may be initiated by the collaborative device. In particular, the collaborative device may obtain a control information associated with a triggering event. The collaborative device may receive/determine the triggering event for performing a sensing procedure based on the control information. The collaborative device may determine a time of performing the sensing procedure based on the triggering event. The collaborative device may forward a signal for a time duration in an event that the sensing procedure is successful.

Accordingly, the UE or the collaborative device may initiate the procedure for forwarding DL data from the network node to the UE, providing greater flexibility for DL data transmission in a network system where the collaborative device may assist in forwarding signal(s) from the network node to the UE.

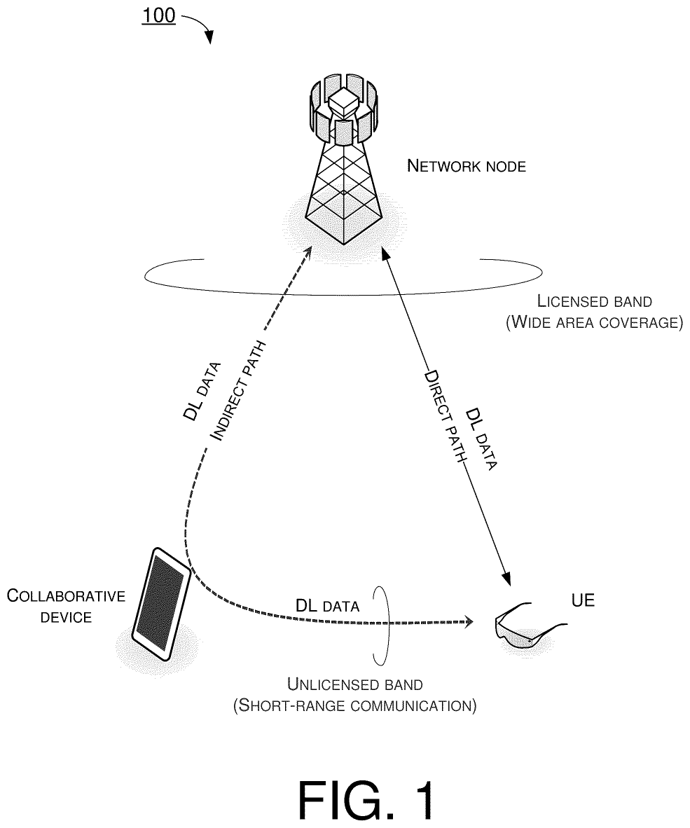

FIG. 1 illustrates an example scenario 100 under schemes in accordance with implementations of the present disclosure. Scenario 100 involves at least one network node, a UE and a collaborative device, which may be a part of a wireless communication network (e.g., an LTE network, a 5G/NR network, an IoT network or a 6G network).

Scenario 100 illustrates the current network framework. The network node may wirelessly connect to the UE and the collaborative device over a licensed band. In other words, the UE and the collaborative device may camp on the same network node which may provide a wide area coverage for long-range communication. The UE and the collaborative device may connect with each other over an unlicensed band. In other words, the UE and the collaborative device may establish a short-range wireless connection with each other to perform a short-range communication over the unlicensed band. It should be noted that in the figures of the present application, the UE may be exemplified as a smart device, and the collaborative device may be exemplified as a smart phone. However, this is for illustrative purposes and not intended to be limiting.

In some embodiments, when the network node has DL data to be transmitted to the UE, the network node may transmit the DL data to the UE via a direct path, and a procedure for forwarding DL data from the network node to the UE via the collaborative device may be initiated by the UE. In particular, the UE may receive/determine a triggering event for performing a Listen-Before-Talk (LBT) procedure.

In some implementations, the triggering event may be associated with at least one occasion (i.e., the triggering event may be derived/determined from the at least one occasion) signaled by the network node while the at least one occasion may be used for at least one reference signal (RS) transmitted from the network node. In other words, receiving/determining the triggering event may include receiving the RS(s). In some cases, the at least one occasion may be signaled in a Radio Resource Control (RRC) by the network node. For example, the network node transmits the RRC to the UE to configure the occasion(s) while the occasion(s) are time/frequency resources where the RS(s) are transmitted by the network node.

More specifically, based on the configured occasion(s) for transmitting the RS(s), the UE may be aware that the network node may transmit the RS(s) at specific occasion(s). Therefore, the UE may perform an LBT procedure prior to the occasion(s) designated for transmitting the RS(s) to acquire a COT for the collaborative device to forward signal.

After acquiring the COT, the UE may transmit COT sharing information including the COT to the collaborative device. FT-forwarding may be performed for the RS(s) by the collaborative device (i.e., the collaborative device's FT-forwarding status may be ON) after (1) the LBT procedure performed by the UE passes, and (2) the UE shares the COT with the collaborative device. Otherwise, the collaborative device may not forward the received RS(s) to the UE. In other words, FT-forwarding may not be performed by the collaborative device (i.e., the collaborative device's FT-forwarding status may be OFF) when the LBT procedure performed by the UE does not pass.

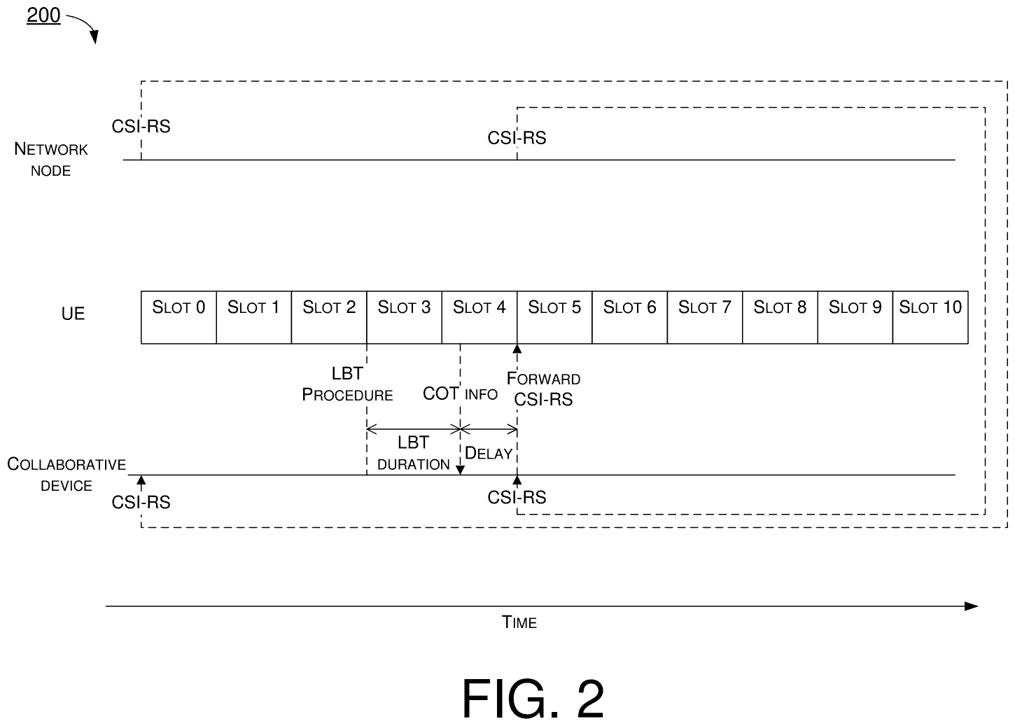

FIG. 2 illustrates an example scenario 200 under schemes in accordance with implementations of the present disclosure. For example, after being configured by the network node, the UE is aware that Channel State Information RS (CSI-RS) is transmitted every 5 slots. Because the UE is aware that the network node transmits the CSI-RS(s) periodically, the UE performs an LBT procedure prior to the start occasion of slot 5 used for transmitting the CSI-RS to acquire a COT for the collaborative device's signal forwarding.

After acquiring the COT, the UE transmits COT sharing information (e.g., COT INFO) including the COT to the collaborative device. The collaborative device then forwards the received CSI-RS(s) to the UE after (1) the UE's LBT procedure passes (i.e., the collaborative device's FT-forwarding status is ON), and (2) the UE shares the COT with the collaborative device. Otherwise, the collaborative device does not forward the received signal to the UE (i.e., the collaborative device's FT-forwarding status is OFF).

It should be noted that, in this example, the UE determines an occasion to start the LBT procedure, ensuring that a duration between this occasion and the start occasion of slot 5, which is used for transmitting the CSI-RS, is equal to or greater than a LBT duration plus a delay caused by transmitting the COT share information (e.g., COT INFO).

In some implementations, the triggering event may be associated with at least one occasion of Physical Downlink Shared Channel (PDSCH) for the UE. In particular, the UE may receive a downlink control information (DCI) associated with the PDSCH. Then, the UE may be aware the at least one occasion of the PDSCH. In other words, receiving/determining the triggering event may include receiving the DCI associated with the PDSCH. Therefore, the UE may perform an LBT procedure prior to the occasion(s) of the PDSCH to acquire a COT for the collaborative device to forward signal.

After acquiring the COT, the UE may transmit COT sharing information including the COT to the collaborative device. FT-forwarding may be performed for the PDSCH by the collaborative device (the collaborative device's FT-forwarding status may be ON) after (1) the LBT procedure performed by the UE passes, and (2) the UE shares the COT with the collaborative device. Otherwise, the collaborative device may not forward the received PDSCH to the UE. In other words, FT-forwarding may not be performed by the collaborative device (the collaborative device's FT-forwarding status may be OFF) when the LBT procedure performed by the UE does not pass.

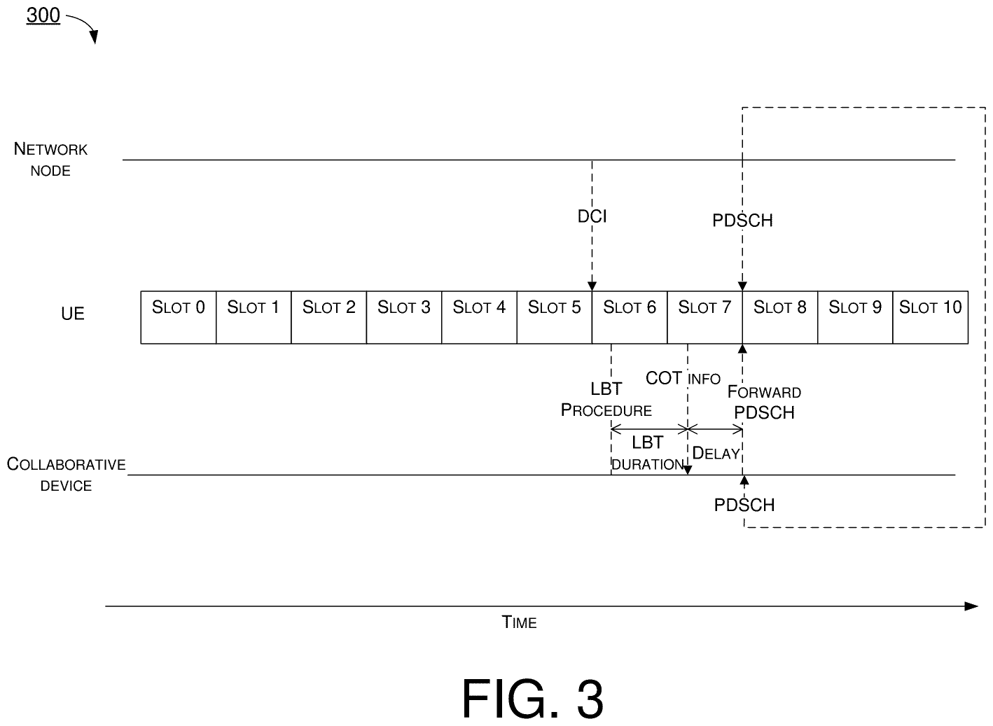

FIG. 3 illustrates an example scenario 300 under schemes in accordance with implementations of the present disclosure. For example, the UE receives a DCI at the beginning of slot 6. The UE obtains occasion(s) of PDSCH by the DCI. Then, the UE performs an LBT procedure in slot 6 prior to the start occasion of the PDSCH to acquire the COT for the collaborative device's signal forwarding.

After acquiring the COT, the UE transmits COT sharing information (e.g., COT INFO) including the COT to the collaborative device. The collaborative device forwards the PDSCH to the UE (i.e., the collaborative device's FT-forwarding status is ON) after (1) the UE's LBT procedure passes, and (2) the UE shares the COT with the collaborative device. Otherwise, the collaborative device does not forward the received signal to the UE (i.e., the collaborative device's FT-forwarding status is OFF).

In some implementations, the triggering event may include an activation command. In particular, the UE may receive the activation command. After receiving the activation command, the UE may repeatedly perform the following operations: (1) performing an LBT procedure to obtain a COT based on the activation command; (2) transmitting the COT to the collaborative device based on the activation command; and (3) receive signal(s) forwarded from the collaborative device if there is any. In some cases, these operations may be repeated until the UE receives a deactivation command.

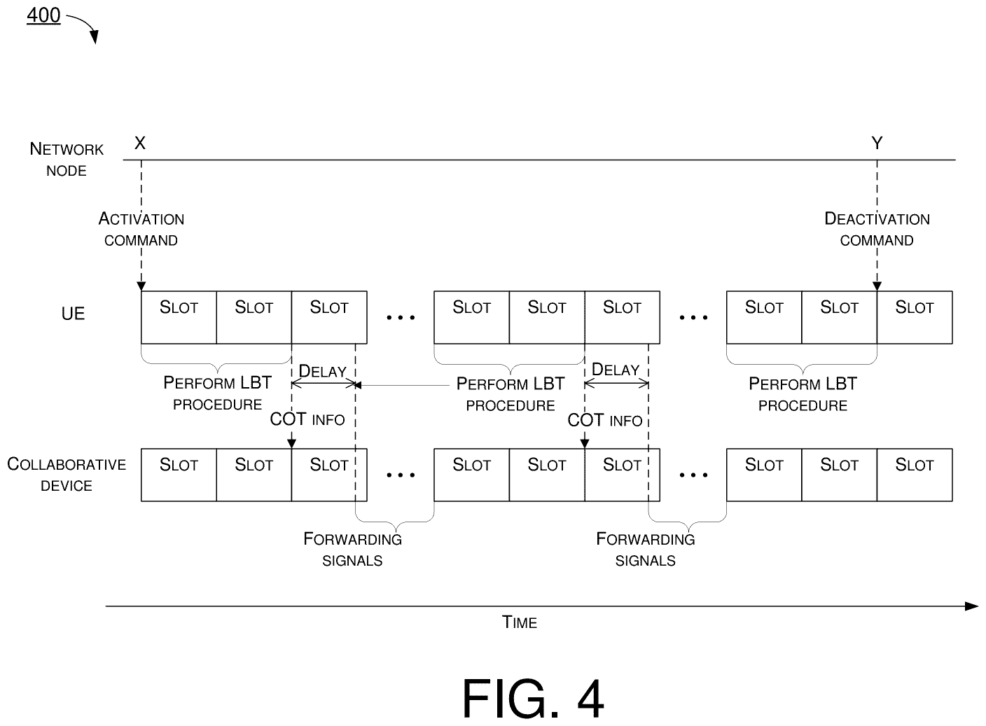

FIG. 4 illustrates an example scenario 400 under schemes in accordance with implementations of the present disclosure. For example, the UE receives an activation command at time ‘X’. After receiving the activation command, the UE repeatedly performs the following operations: (1) performing an LBT procedure to obtain a COT based on the activation command; (2) transmitting the COT to the collaborative device based on the activation command; and (3) receiving signal(s) forwarded from the collaborative device if there is any. In this example, the collaborative device starts to forward the signal(s) right after the LBT procedure. The UE stops repeatedly performing these operations when the UE receives a deactivation command at time ‘Y’ (i.e., multiple LBT procedures, multiple transmissions of COTs and/or multiple receptions of the signals can be performed before receiving the deactivation command).

In some embodiments, when the network node has DL data to be transmitted to the UE, the network node may transmit the DL data to the UE via a direct path, and a procedure for forwarding DL data from the network node to the UE via the collaborative device may be initiated by the collaborative device. In particular, the collaborative device may obtain a control information associated with a triggering event. The control information may include network information between the network node and the UE, and network information between the UE and the collaborative device. Then, the collaborative device may receive/determine the triggering event for performing an LBT procedure based on the control information. The collaborative device may connect with the UE at any appropriate time.

In some implementations, the triggering event may be associated with at least one occasion (i.e., the triggering event may be derived/determined from the at least one occasion) signaled by the network node while the at least one occasion may be used for at least one reference signal (RS) transmitted from the network node. In some cases, the at least one occasion may be signaled: (1) in an RRC by the network node, or (2) in a configuration associated with RS by the UE. For example, the network node transmits the RRC to the collaborative device to configure the occasion(s) while the occasion(s) are the time/frequency resources where the RS(s) are transmitted by the network node. For another example, the UE transmits the RS associated configuration to the collaborative device to configure the occasion(s) while the occasion(s) are the time/frequency resources where the RS(s) are transmitted by the network node.

More specifically, based on the configured occasion(s) for transmitting the RS(s), the collaborative device may be aware that the network node may transmit the RS(s) at certain occasion(s). Therefore, the collaborative device may perform an LBT procedure prior to the occasion(s) for transmitting the RS(s).

After performing the LBT procedure, the collaborative device may perform FT-forwarding for the RS(s) (i.e., the collaborative device's FT-forwarding status may be ON) after the LBT procedure passes. Otherwise, the collaborative device may not forward the received signal to the UE. In other words, the collaborative device may not perform FT-forwarding (i.e., the collaborative device's FT-forwarding status may be OFF) when the LBT procedure does not pass.

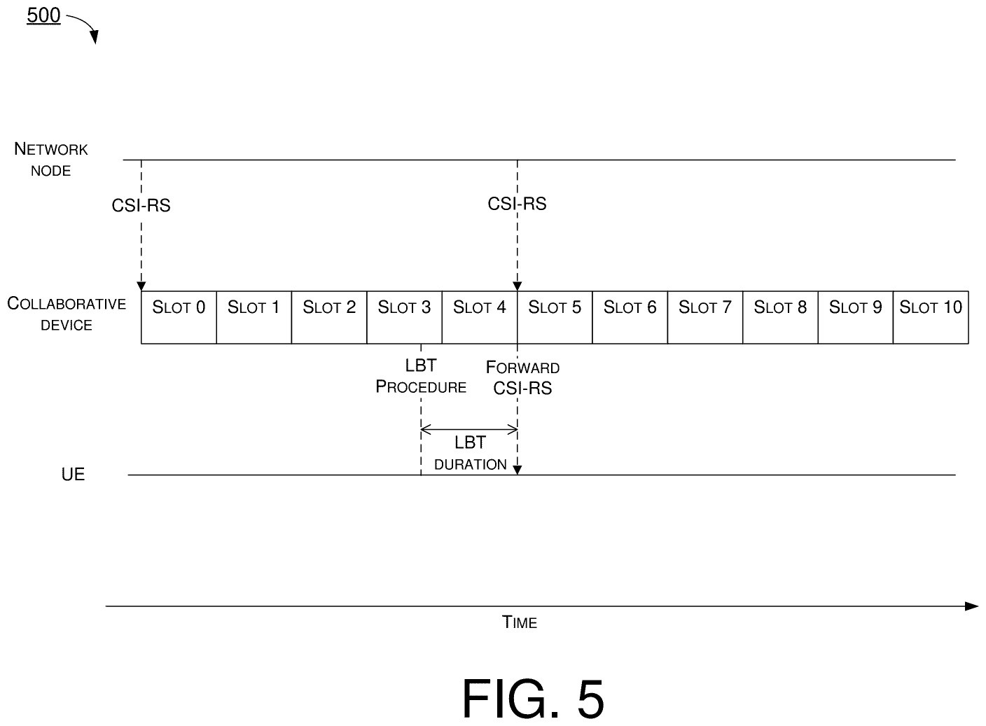

FIG. 5 illustrates an example scenario 500 under schemes in accordance with implementations of the present disclosure. For example, after being configured by the network node, the UE measures CSI-RS(s) every 5 slots. The collaborative device is then aware that the network node transmits the CSI-RS(s) periodically by an RRC from network or an RS associated configuration from the UE. Then, the collaborative device performs an LBT procedure in a slot (slot 3 in this example) prior to the occasion(s) of slot 5 used for transmitting the CSI-RS(s) to obtain permission to use unlicensed band (i.e., COT) before slot 5.

After performing the LBT procedure, the collaborative device performs FT-forwarding for the RS(s) (i.e., the collaborative device's FT-forwarding status is ON) after the LBT procedure passes. Otherwise, the collaborative device does not forward the received RS(s) to the UE (i.e., the collaborative device's FT-forwarding status is OFF).

In some implementations, the triggering event may be associated with at least one occasion of PDSCH used for the UE. In particular, the collaborative device may receive (e.g., eavesdrop) a DCI associated with the PDSCH intended to the UE. Then, the collaborative device may be aware the at least one occasion of the PDSCH intended to the UE. Therefore, the collaborative device may perform an LBT procedure prior to the occasion(s) of the PDSCH. In some cases, to successfully decode the DCI associated with the PDSCH intended the UE, the control information may include a scrambling rule (e.g., Radio Network Temporary Identifier (RNTI) used to scramble PDCCH intended to the UE or a common rule for the UE and the collaborative device) for decoding Physical Downlink Control Channel (PDCCH) carrying the DCI associated with the PDSCH intended to the UE.

After performing the LBT procedure, the collaborative device may perform FT-forwarding for the PDSCH (i.e., the collaborative device's FT-forwarding status may be ON) after the LBT procedure passes. Otherwise, the collaborative device may not forward the received PDSCH to the UE. In other words, the collaborative device may not perform FT-forwarding (i.e., the collaborative device's FT-forwarding status may be OFF) when the LBT procedure does not pass.

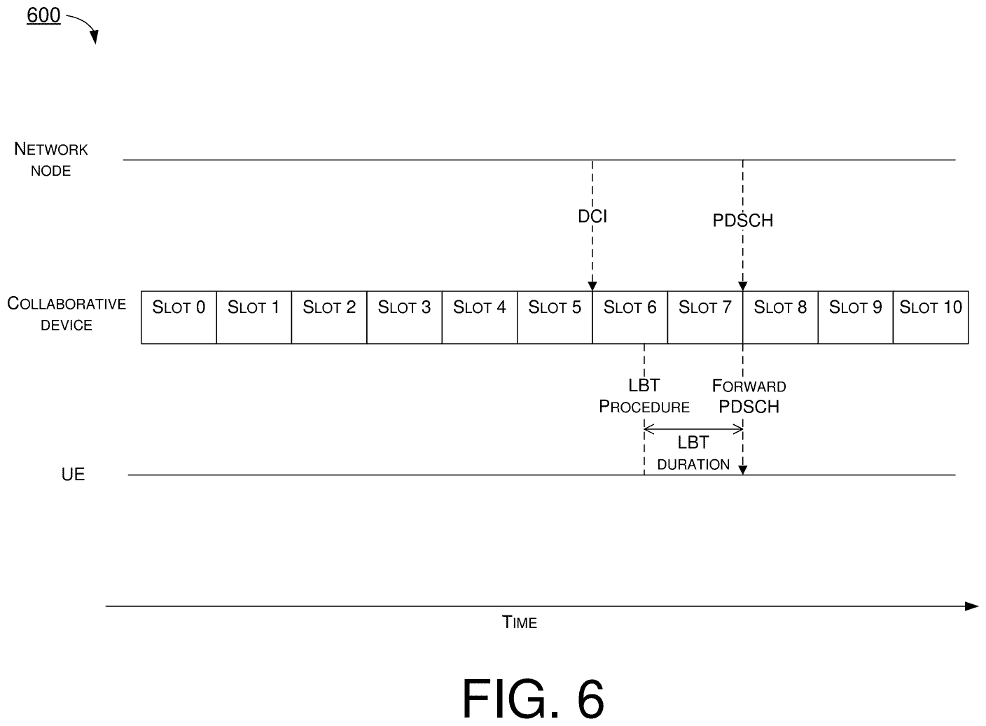

FIG. 6 illustrates an example scenario 600 under schemes in accordance with implementations of the present disclosure. For example, the collaborative device receives a DCI at the beginning of slot 6. The collaborative device obtains occasion(s) of PDSCH by the DCI while there are 2 slots between the DCI and the PDSCH. Then, the collaborative device performs an LBT procedure in slot 6 prior to the occasion(s) of the PDSCH.

After performing the LBT procedure, the collaborative device performs FT-forwarding for the PDSCH (i.e., the collaborative device's FT-forwarding status is ON) after the LBT procedure passes. Otherwise, the collaborative device does not forward the received PDSCH to the UE (i.e., the collaborative device's FT-forwarding status is OFF).

In some implementations, the triggering event may include an activation command. In particular, the collaborative device may receive the activation command. After receiving the activation command, the collaborative device may repeatedly perform the following operations: (1) performing an LBT procedure based on the activation command; and (2) forwarding signal(s) if there is any. In some cases, these operations may be repeated until the collaborative device receives a deactivation command.

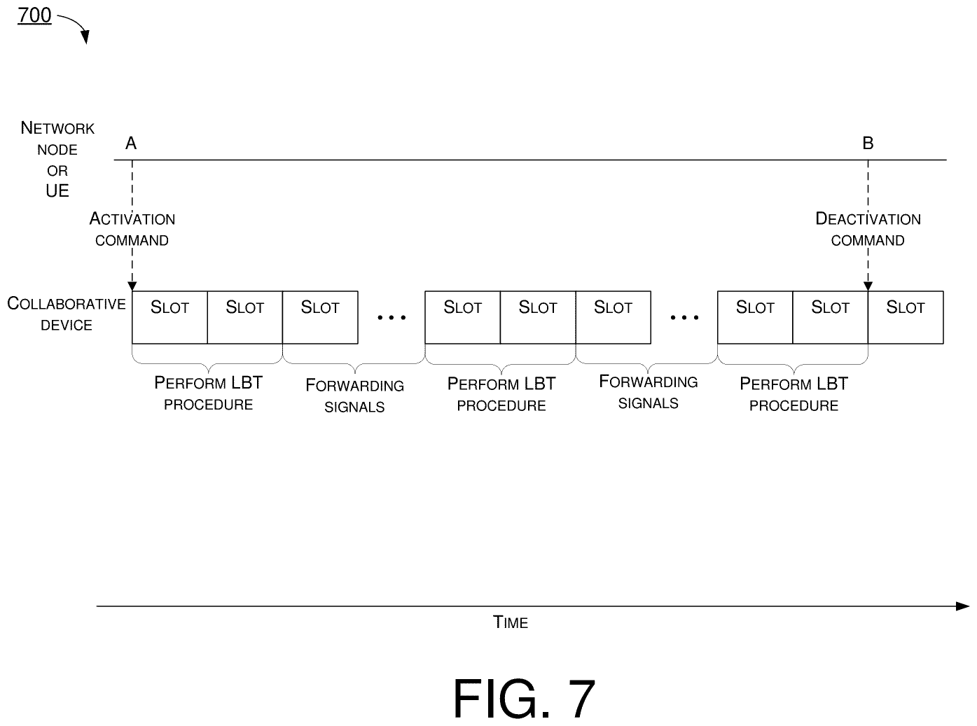

FIG. 7 illustrates an example scenario 700 under schemes in accordance with implementations of the present disclosure. For example, the collaborative device receives an activation command from the network node or the UE at time ‘A’. After receiving the activation command, the collaborative device repeatedly performs the following operations: (1) performing an LBT procedure based on the activation command; and (2) forwarding signal(s) if there is any. The collaborative device stops repeatedly performing these operations when the collaborative device receives a deactivation command from the network node or the UE at time ‘B’ (i.e., multiple LBT procedures and/or multiple forwards of the signals can be performed before receiving the deactivation command).

It should be noted that, in the previous descriptions, “LBT procedure passes” may represent that the collaborative device/the UE successfully perform an LBT procedure over the unlicensed band (i.e., the collaborative device/the UE occupy unlicensed band resource and are capable of transmitting signal over the occupied unlicensed band resource).

In some implementations, when the procedure for forwarding DL data from the network node to the UE via the collaborative device is initiated by the collaborative device, a Contention Window (CW) size associated with the LBT procedure may require adjustment. In particular, the collaborative device may obtain a first control information associated with decoding status of a set of PDSCHs that had been transmitted from a network node to the UE in the licensed band. The collaborative device may determine a CW size according to the first control information. The collaborative device may perform the LBT procedure based on the CW size to acquire a COT in the unlicensed band between the collaborative device and the UE.

Then, the collaborative device may forward at least one signal received in the licensed band to the unlicensed band in the COT. The CW size may define required backoff periods without channel activity before a transmission or a forwarding is initiated.

In some cases, the CW size may be set to a minimum value in an event that the first control information indicates that at least one PDSCH within the set of PDSCHs is decodable by the UE. The CW size may be set to a next higher allowed value in an event that the first control information indicates that each PDSCH within the set of PDSCHs is not decodable by the UE. For example, if the maximum value of CW size has been set while the UE does not decode the set of PDSCHs, the maximum value of CW size remains. If the maximum value of CW size has been used for ‘k’ times, the CW size is set to minimum value. ‘k’ is a non-negative integer.

In some cases, the set of PDSCHs may include one or multiple PDSCHs within a reference duration. In some cases, the collaborative device may transmit a second control information indicating the reference duration to the UE and/or the network node. For example, the collaborative device transmits the second control information to the UE and/or the network node while the second control information includes information about the starting time of a COT.

In some cases, the first control information may indicate whether the set of PDSCHs is decodable or not, and the first control information may be signaled by the network node or the UE.

### Illustrative Implementations

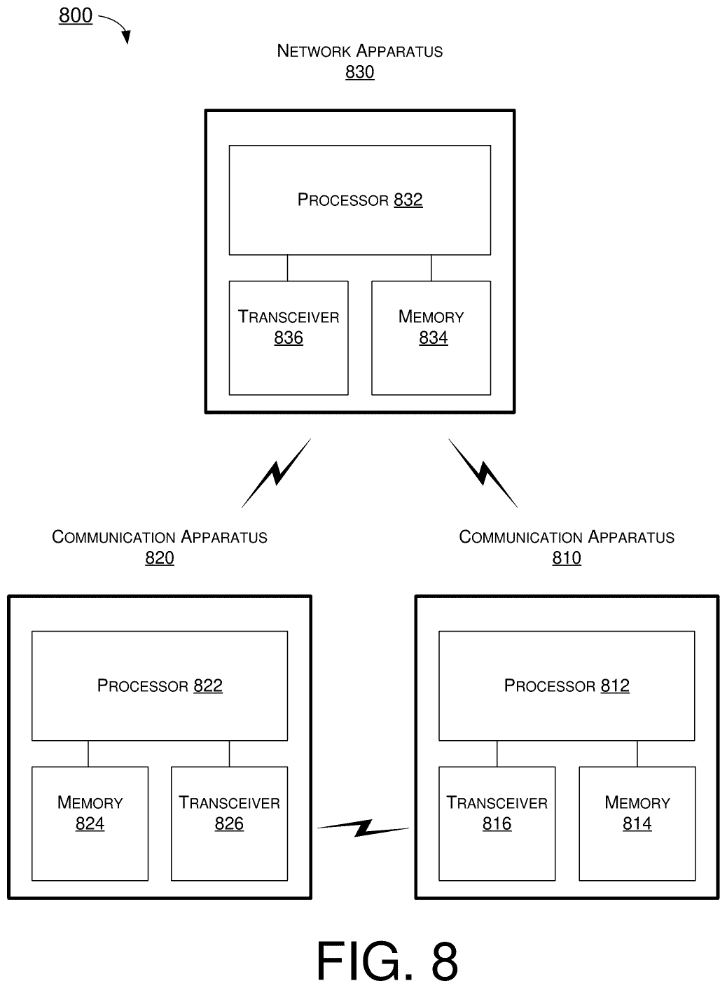

FIG. 8 illustrates an example communication system 800 having an example communication apparatus 810, an example communication apparatus 820, and an example network apparatus 830 in accordance with an implementation of the present disclosure. Each of communication apparatus 810, communication apparatus 820 and network apparatus 830 may perform various functions to implement schemes, techniques, processes and methods described herein pertaining to initiating downlink procedure associated with unlicensed band in mobile communications, including scenarios/schemes described above as well as process 900 and process 1000 described below.

Communication apparatus 810/820 may be a part of an electronic apparatus, which may be a UE such as a portable or mobile apparatus, a wearable apparatus, a mobile communication apparatus or a computing apparatus. For instance, communication apparatus 810/820 may be implemented in a smartphone, a smartwatch, a personal digital assistant, a digital camera, or a computing equipment such as a tablet computer, a laptop computer or a notebook computer. Communication apparatus 810/820 may also be a part of a machine type apparatus, which may be an IoT, NB-IoT, or IIoT apparatus such as an immobile or a stationary apparatus, a home apparatus, a wire communication apparatus or a computing apparatus. For instance, communication apparatus 810/820 may be implemented in a smart thermostat, a smart fridge, a smart door lock, a wireless speaker or a home control center. Alternatively, communication apparatus 810/820 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 810/820 may include at least some of those components shown in FIG. 8 such as a processor 812/822, for example. Communication apparatus 810/820 may further include one or more other components not pertinent to the proposed scheme of the present disclosure (e.g., internal power supply, display device and/or user interface device), and, thus, such component(s) of communication apparatus 810/820 are neither shown in FIG. 8 nor described below in the interest of simplicity and brevity.

Network apparatus 830 may be a part of a network device, which may be a network node such as a satellite, a base station, a small cell, a router or a gateway. For instance, network apparatus 830 may be implemented in an eNodeB in an LTE network, in a gNB in a 5G/NR, IoT, NB-IoT or IIoT network or in a satellite or base station in a 6G network. Alternatively, network apparatus 830 may be implemented in the form of one or more IC chips such as, for example and without limitation, one or more single-core processors, one or more multi-core processors, or one or more RISC or CISC processors. Network apparatus 830 may include at least some of those components shown in FIG. 8 such as a processor 832, for example. Network apparatus 830 may further include one or more other components not pertinent to the proposed scheme of the present disclosure (e.g., internal power supply, display device and/or user interface device), and, thus, such component(s) of network apparatus 830 are neither shown in FIG. 8 nor described below in the interest of simplicity and brevity.

In one aspect, each of processor 812, processor 822 and processor 832 may be implemented in the form of one or more single-core processors, one or more multi-core processors, or one or more CISC processors. That is, even though a singular term “a processor” is used herein to refer to processor 812, processor 822 and processor 832, each of processor 812, processor 822 and processor 832 may include multiple processors in some implementations and a single processor in other implementations in accordance with the present disclosure. In another aspect, each of processor 812, processor 822 and processor 832 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 812, processor 822 and processor 832 is a special-purpose machine specifically designed, arranged and configured to perform specific tasks including initiating downlink procedure associated with unlicensed band in a device (e.g., as represented by communication apparatus 810 and communication apparatus 820) and a network (e.g., as represented by network apparatus 830) in accordance with various implementations of the present disclosure.

In some implementations, communication apparatus 810 may also include a transceiver 816 coupled to processor 812 and capable of wirelessly transmitting and receiving data. In other words, processor 812 may transceive the data such as configuration, message, signal, information, indicator, etc. via transceiver 816. In some implementations, communication apparatus 810 may further include a memory 814 coupled to processor 812 and capable of being accessed by processor 812 and storing data therein. In some implementations, communication apparatus 820 may also include a transceiver 826 coupled to processor 822 and capable of wirelessly transmitting and receiving data. In other words, processor 822 may transceive the data such as configuration, message, signal, information, indicator, etc. via transceiver 826. In some implementations, communication apparatus 820 may further include a memory 824 coupled to processor 822 and capable of being accessed by processor 822 and storing data therein. In some implementations, network apparatus 830 may also include a transceiver 836 coupled to processor 832 and capable of wirelessly transmitting and receiving data. In other words, processor 832 may transceive the data such as configuration, message, signal, information, indicator, etc. via transceiver 836. In some implementations, network apparatus 830 may further include a memory 834 coupled to processor 832 and capable of being accessed by processor 832 and storing data therein. Accordingly, communication apparatus 810, communication apparatus 820 and network apparatus 830 may wirelessly communicate with each other via transceiver 816, transceiver 826 and transceiver 836, respectively. To aid better understanding, the following description of the operations, functionalities and capabilities of each of communication apparatus 810, 820 and network apparatus 830 is provided in the context of a mobile communication environment in which communication apparatus 810, 820 are implemented in or as a communication apparatus or a UE and network apparatus 830 is implemented in or as a network node of a communication network.

In some implementations, each of memory 814, 824 and 834 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 814, 824 and 834 may include a type of read-only memory (ROM) such as mask ROM, programmable ROM (PROM), erasable programmable ROM (EPROM) and/or electrically erasable programmable ROM (EEPROM). Alternatively, or additionally, each of memory 814, 824 and 834 may include a type of non-volatile random-access memory (NVRAM) such as flash memory, solid-state memory, ferroelectric RAM (FeRAM), magnetoresistive RAM (MRAM) and/or phase-change memory.

### Illustrative Processes

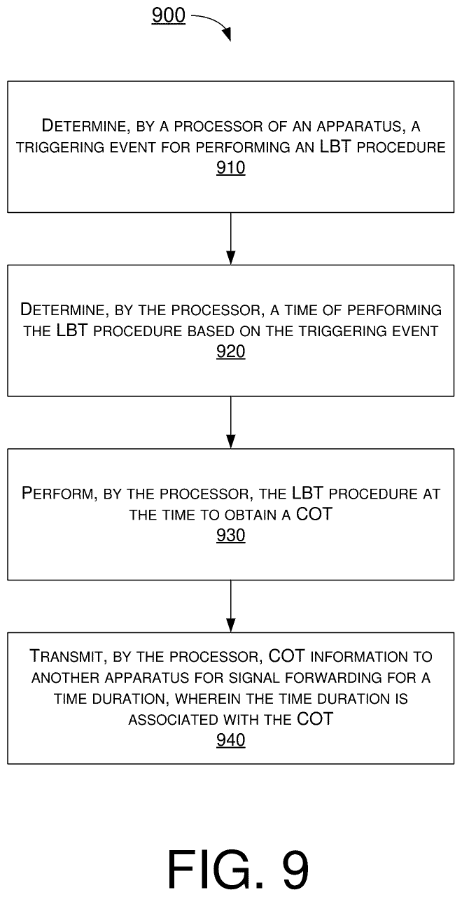

FIG. 9 illustrates an example process 900 in accordance with an implementation of the present disclosure. Process 900 may be an example implementation of above scenarios/schemes, whether partially or completely, with respect to initiating downlink procedure associated with unlicensed band in mobile communications of the present disclosure. Process 900 may represent an aspect of implementation of features of communication apparatus 810. Process 900 may include one or more operations, actions, or functions as illustrated by one or more of blocks 910 to 940. Although illustrated as discrete blocks, various blocks of process 900 may be divided into additional blocks, combined into fewer blocks, or eliminated, depending on the desired implementation. Moreover, the blocks of process 900 may be executed in the order shown in FIG. 9 or, alternatively, in a different order. Process 900 may be implemented by communication apparatus 810 or any suitable communication device or machine type devices. Solely for illustrative purposes and without limitation, process 900 is described below in the context of communication apparatus 810. Process 900 may begin at block 910.

At block 910, process 900 may involve processor 812 of communication apparatus 810 determining a triggering event for performing an LBT procedure. Process 900 may proceed from block 910 to block 920.

At block 920, process 900 may involve processor 812 determining a time of performing the LBT procedure based on the triggering event. Process 900 may proceed from block 920 to block 930.

At block 930, process 900 may involve processor 812 performing the LBT procedure at the time to obtain a COT. Process 900 may proceed from block 930 to block 940.

At block 940, process 900 may involve processor 812 transmitting COT information to another apparatus (e.g., the communication apparatus 820) for signal forwarding for a time duration. The time duration may be associated with the COT.

In some implementations, the triggering event may be associated with at least one occasion signaled by a network node (e.g., network apparatus 830).

In some implementations, the at least one occasion may be used for at least one reference signal transmitted from the network node.

In some implementations, the triggering event may be associated with at least one occasion of PDSCH used for communication apparatus 810.

In some implementations, the triggering event may include an activation command. Process 800 may further involve processor 812 performing one or more additional LBT procedures to obtain one or more additional COTs based on the activation command. Process 800 may further involve processor 812 transmitting the one or more additional COTs to the another apparatus based on the activation command.

In some implementations, process 800 may further involve processor 812 receiving a deactivation command to stop performing the one or more additional LBT procedures.

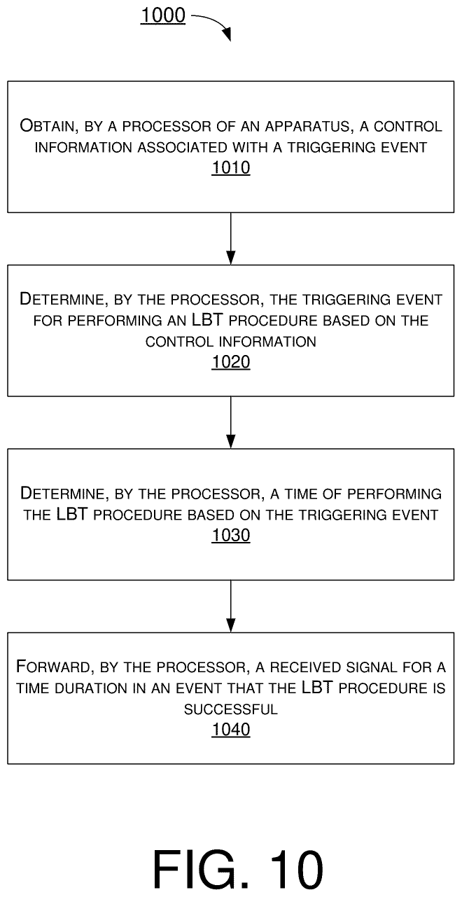

FIG. 10 illustrates an example process 1000 in accordance with an implementation of the present disclosure. Process 1000 may be an example implementation of above scenarios/schemes, whether partially or completely, with respect to initiating downlink procedure associated with unlicensed band in mobile communications of the present disclosure. Process 1000 may represent an aspect of implementation of features of communication apparatus 820. Process 1000 may include one or more operations, actions, or functions as illustrated by one or more of blocks 1010 to 1040. Although illustrated as discrete blocks, various blocks of process 1000 may be divided into additional blocks, combined into fewer blocks, or eliminated, depending on the desired implementation. Moreover, the blocks of process 1000 may be executed in the order shown in FIG. 10 or, alternatively, in a different order. Process 1000 may be implemented by communication apparatus 820 or any suitable communication device or machine type devices. Solely for illustrative purposes and without limitation, process 1000 is described below in the context of communication apparatus 820. Process 1000 may begin at block 1010.

At block 1010, process 1000 may involve processor 822 of communication apparatus 820 obtaining a control information associated with a triggering even. Process 1000 may proceed from block 1010 to block 1020.

At block 1020, process 1000 may involve processor 822 determining the triggering event for performing an LBT procedure based on the control information. Process 1000 may proceed from block 1020 to block 1030.

At block 1030, process 1000 may involve processor 822 determining a time of performing the LBT procedure based on the triggering event. Process 1000 may proceed from block 1030 to block 1040.

At block 1040, process 1000 may involve processor 822 forwarding a received signal for a time duration in an event that the LBT procedure is successful.

In some implementations, process 1000 may further involve processor 822 connecting with another apparatus (e.g., communication apparatus 810) to forward the signal.

In some implementations, the triggering event may be associated with at least one occasion signaled by a network node (e.g., network apparatus 830).

In some implementations, the at least one occasion may be used for at least one reference signal transmitted from the network node.

In some implementations, the at least one occasion may be signaled in an RRC by the network node or signaled in a configuration by another apparatus.

In some implementations, the triggering event may be associated with at least one occasion of PDSCH used for the another apparatus.

In some implementations, the control information may include a scrambling rule for decoding PDCCH used for the another apparatus.

In some implementations, the triggering event may include an activation command received from the network node or the another apparatus. Process 1000 may further involve processor 822 performing one or more additional LBT procedures based on the activation command.

In some implementations, process 1000 may further involve processor 822 receiving a deactivation command from the network node or the another apparatus to stop performing the one or more additional LBT procedures.

In some implementations, process 1000 may further involve processor 822 obtaining a first control information associated with decoding status of a set of PDSCHs had been transmitted form the network node to the another apparatus in the licensed band. Process 1000 may further involve processor 822 determining a CW size according to the first control information. Process 1000 may further involve processor 822 performing the LBT procedure based on the CW size to acquire a COT in an unlicensed band. Process 1000 may further involve processor 822 forwarding at least one signal received in a licensed band to the unlicensed band in the COT. The CW size may define required backoff periods without channel activity before a transmission or a forwarding is initiated.

In some implementations, the CW size may be set to a minimum value in an event that the first control information indicates that at least one PDSCH within the set of PDSCHs is decodable by the another apparatus.

In some implementations, the CW size may be set to a next higher allowed value in an event that the first control information indicates that each PDSCH within the set of PDSCHs is not decodable by the another apparatus.

In some implementations, the set of PDSCHs may include one or multiple PDSCHs within a reference duration.

In some implementations, process 1000 may further involve processor 822 transmitting a second control information indicating the reference duration to at least one of the another apparatus and the network node.

In some implementations, the first control information may indicate whether the set of PDSCHs is decodable or not, and the first control information may be signaled by the network node or the another apparatus.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
determining, by a processor of an apparatus, a triggering event for performing a Listen-Before-Talk (LBT) procedure;
determining, by the processor, a time of performing the LBT procedure based on the triggering event;
performing, by the processor, the LBT procedure at the time to obtain a Channel Occupancy Time (COT); and
transmitting, by the processor, COT information to another apparatus for signal forwarding for a time duration, wherein the time duration is associated with the COT.

2. The method of claim 1, wherein the triggering event is associated with at least one occasion signaled by a network node.

3. The method of claim 2, wherein the at least one occasion is for at least one reference signal transmitted from the network node.

4. The method of claim 1, wherein the triggering event is associated with at least one occasion of Physical Downlink Shared Channel (PDSCH) for the apparatus.

5. The method of claim 1, wherein the triggering event includes an activation command, and the method further comprises:
performing, by the processor, one or more additional LBT procedures to obtain one or more additional COTs based on the activation command.

6. The method of claim 5, further comprising:
receiving, by the processor, a deactivation command to stop performing the one or more additional LBT procedures.

7. A method, comprising:
obtaining, by a processor of an apparatus, a control information associated with a triggering event;
determining, by the processor, the triggering event for performing a Listen-Before-Talk (LBT) procedure based on the control information;
determining, by the processor, a time of performing the LBT procedure based on the triggering event; and
forwarding, by the processor, a received signal for a time duration in an event that the LBT procedure is successful.

8. The method of claim 7, wherein the triggering event is associated with at least one occasion signaled by a network node.

9. The method of claim 8, wherein the at least one occasion is for at least one reference signal transmitted from the network node.

10. The method of claim 9, wherein the at least one occasion is signaled in a Radio Resource Control (RRC) by the network node or signaled in a configuration by another apparatus.

11. The method of claim 7, further comprising:
connecting, by the processor, with another apparatus to forward the signal.

12. The method of claim 11, wherein the triggering event is associated with at least one occasion of Physical Downlink Shared Channel (PDSCH) for the another apparatus.

13. The method of claim 12, wherein the control information includes a scrambling rule for decoding Physical Downlink Control Channel (PDCCH) for the another apparatus.

14. The method of claim 11, wherein the triggering event includes an activation command received from a network node or the another apparatus, and the method further comprises:
performing, by the processor, one or more additional LBT procedures based on the activation command.

15. The method of claim 14, further comprising:
receiving, by the processor, a deactivation command from the network node or the another apparatus to stop performing the one or more additional LBT procedures.

16. The method of claim 11, further comprising:
obtaining, by the processor, a first control information associated with decoding status of a set of Physical Downlink Shared Channels (PDSCHs) had been transmitted to the another apparatus from a network node in a licensed band;
determining, by the processor, a contention window (CW) size according to the first control information;
performing, by the processor, the LBT procedure based on the CW size to acquire a Channel Occupancy Time (COT) in an unlicensed band;
forwarding, by the processor, at least one signal received in a licensed band to the unlicensed band in the COT,
wherein the CW size defines required backoff periods without channel activity before a transmission or a forwarding is initiated.

17. The method of claim 16, wherein the CW size is set to a minimum value in an event that the first control information indicates that at least one PDSCH within the set of PDSCHs is decodable by the another apparatus.

18. The method of claim 16, wherein the CW size is set to a next higher allowed value in an event that the first control information indicates that each PDSCH within the set of PDSCHs is not decodable by the another apparatus.

19. The method of claim 16, wherein the set of PDSCHs includes one or multiple PDSCHs within a reference duration.

20. The method of claim 16, wherein the first control information indicates whether the set of PDSCHs is decodable or not, and the first control information is signaled by the network node or the another apparatus.
